(19) United States
(12) Patent Application Publication
(10) Pub. No.: US 2014/0214645 A1
(43) Pub. Date: Jul. 31, 2014

(54) EDUCATIONAL SYSTEMS, SOFTWARE, AND METHODS FOR TRAINING IN THE FIELD OF VALUING AND COMPARING OPTIONS

(71) Applicant: OPTIONS CONSULTING GROUP LLC, New York, NY (US)

(72) Inventor: Felix Frey, New York, NY (US)

(73) Assignee: OPTIONS CONSULTING GROUP LLC, New York, NY (US)

(21) Appl. No.: 13/753,323

(22) Filed: Jan. 29, 2013

(51) Int. Cl. G06Q 40/04

(52) U.S. Cl. CPC G06Q 40/04
USPC 705/37

(57) ABSTRACT

Computer-implemented methods of investor education in the field of valuing and selecting stock options for investment.

### BACKGROUND OF THE INVENTION

An option is a contract which gives the owner the right, but not the obligation, to buy or sell an underlying asset or instrument at a specified strike price on or before a specified date. The seller incurs a corresponding obligation to fulfill the transaction if the long holder elects to exercise the option prior to expiration. The buyer pays a premium to the seller for this right. An option which conveys the right to buy something at a specific price is called a call; an option which conveys the right to sell something at a specific price is called a put.

### SUMMARY OF THE INVENTION

Option valuation, which is a critical aspect of trading, is a topic of ongoing research in academic and practical finance. Traditionally, option valuation and trading was conducted almost entirely by finance professionals. However, to an increasing extent, amateur traders and those without prior training are engaging in these practices.

To gauge the “cheapness” of an option, professional options traders traditionally compare Implied Volatility (IV) to Historical Volatility (HV). IV is a percentage which represents the market's best guess of the stock's possible price range over a certain period of time in the future. HV defines how volatile a stock behaved over a certain period of time. While IV changes with the temperament of the market, the HV is a percentage number that represents how a stock's price actually moved over a certain period of time in the past. This comparison simply evaluates what has actually happened in the past to what the market expects to happen in the future.

Using traditional methods, a professional investor simply takes the HV and compares it to the IV, using the following rules: if the IV>HV, then the option is “expensive”; if the IV<HV, then the option is “cheap.” Problematically, when using existing methodologies, professional options traders look to the past to make an educated guess about the future. Unfortunately, while history does give the investor a starting point to work from, the market is forward looking and may have already priced all that past information into the current option premium. Simply because an option is “expensive” or “cheap” when compared to historical measures, does not take into account potential future events or outcomes that may significantly affect the stock.

Comparing current IV to historical data is not the defining answer, but simply helps the investor gauge the option's relative value from the past. There is a long-felt and unmet need for methods, systems, and software to simplify options valuation and help investors focus on and analyze future price expectations when trading options. In some embodiments, the inventions disclosed herein utilize an investor's future stock price expectations to determine whether an option is “cheap” or “expensive.” Advantageously, in some embodiments, the methods of education and training disclosed herein involve teaching investors how to compare the market's expectations to their own expectations. When these expectations diverge, an opportunity to trade options exists. Additional advantages of the inventions disclosed herein include, but are not limited to, helping investors utilize option premiums to determine the market's expectations and simplifying the comparison between market's expectations and an individual investor's expectations.

In one aspect, disclosed herein are computer-implemented methods of investor education in the field of valuing options, the method comprising the steps of: demonstrating calculation of probability of an option expiring ITM; demonstrating calculation of profit expected by the market if the option expires ITM; demonstrating calculation of the market's expected stock price if the option expires ITM; demonstrating calculation of the market's expected leverage for the option if the option expires ITM; demonstrating calculation of the investor's expected profit for the option; demonstrating calculation of the investor's expected leverage for the option; and providing access to a tool for transforming the probability of the option expiring ITM into the market's expected stock price if the option expires ITM, the market's expected leverage for the option, and the investor's expected leverage, the tool created by instructions executed by a processing device; whereby at least one investor is educated in the field of valuing options; provided that one or more of the calculations are performed by a processing device. In some embodiments, the investor's expected profit for the option is derived from the investor's target stock price. In some embodiments, the investor's expected leverage for the option is derived from the investor's target stock price. In some embodiments, the calculation of profit expected by the market if the option expires ITM utilizes a formula consisting essentially of: (probability of the option expiring OTM) (loss expected by the market if the option expires OTM)/(probability of the option expiring ITM). In some embodiments, the option is a call, wherein the calculation of the market's expected stock price if the option expires ITM utilizes a formula consisting essentially of: strike price+premium+profit expected by the market if the option expires ITM. In other embodiments, the option is a put, wherein the calculation of the market's expected stock price if the option expires ITM utilizes a formula consisting essentially of: strike price−premium−profit expected by the market if the option expires ITM. In some embodiments, the calculation of the market's expected leverage for the option utilizes a formula consisting essentially of: profit expected by the market if the option expires ITM/premium. In further embodiments, the market's expected leverage for the option is expressed as a ratio profit expected by the market if the option expires ITM per dollar of premium:1. In some embodiments, the calculation of the market's expected leverage for the option utilizes a formula consisting essentially of: probability of the option expiring OTM/probability of the option expiring ITM. In some embodiments, the option is a call, wherein the calculation of the investor's expected profit for the option utilizes a formula consisting essentially of: target stock price−strike price−premium. In other embodiments, the option is a put, wherein the calculation of the investor's expected profit for the option utilizes a formula consisting essentially of: strike price−target stock price−premium. In some embodiments, the calculation of the investor's expected leverage for the option utilizes a formula consisting essentially of: investor's expected profit for the option/premium. In further embodiments, the investor's expected leverage for the option is expressed as a ratio of expected profit for the option per dollar of premium:1. In some embodiments, the tool for transforming the probability of the option expiring ITM accepts inputs comprising one or more of: type of option (call or put), stock price, strike price, volatility, days to expiry of the option, interest rate, dividend yield, and target stock price, ticker, and expiration date. In some embodiments, the tool for transforming the probability of the option expiring ITM generates outputs comprising one or more of: premium, probability of option expiring ITM, market's expected stock price, market's expected leverage, and investor's expected leverage. In some embodiments, the method further comprises the step of demonstrating the determination of an option margin of safety, the option margin of safety consisting of: the difference between the investor's expectations and the market's expectations with regard to stock price or leverage. In some embodiments, the method further comprises the step of demonstrating the advantage of: buying a call option where investor's target stock price>the market's expected stock price if the option expires ITM; and selling a call option where investor target stock price<the market's expected stock price if the option expires ITM. In some embodiments, the method further comprises the step of demonstrating the advantage of: selling a put option where the investor's target stock price>the market's expected stock price if the option expires ITM; and buying a put option where the investor's target stock price<the market's expected stock price if the option expires ITM. In some embodiments, the method further comprises the step of demonstrating the advantage of: buying an option where the investor's expected leverage>the market's expected leverage; and selling an option where the investor's expected leverage<the market's expected leverage. In some embodiments, the method further comprises the step of demonstrating the effect of expiration date on valuation of the option. In some embodiments, the method further comprises the step of demonstrating the effect of target stock price on valuation of the option. In some embodiments, the method further comprises the step of demonstrating a technique for >70% probability of ITM call options, comprising evaluating the corresponding put option with the same strike and expiration. In some embodiments, the method further comprises the step of demonstrating a technique for >70% probability of ITM put options, comprising evaluating the corresponding call option with the same strike and expiration.

In another aspect, disclosed herein are computer-implemented methods of investor education in the field of valuing options, the method comprising the steps of: demonstrating calculation of probability of an option expiring ITM; demonstrating calculation of profit expected by the market if the option expires ITM; demonstrating calculation of the market's expected stock price if the option expires ITM; demonstrating calculation of the investor's expected profit for the option; and providing access to a tool for transforming the probability of the option expiring ITM into the market's expected stock price if the option expires ITM, the tool created by instructions executed by a processing device; whereby at least one investor is educated in the field of valuing options; provided that one or more of the calculations are performed by a processing device. In some embodiments, the investor's expected profit for the option is derived from the investor's target stock price. In some embodiments, the calculation of profit expected by the market if the option expires ITM utilizes a formula consisting essentially of: (probability of the option expiring OTM) (loss expected by the market if the option expires OTM)/(probability of the option expiring ITM). In some embodiments, the option is a call, wherein the calculation of the market's expected stock price if the option expires ITM utilizes a formula consisting essentially of: strike price+premium+profit expected by the market if the option expires ITM. In other embodiments, the option is a put, wherein the calculation of the market's expected stock price if the option expires ITM utilizes a formula consisting essentially of: strike price−premium−profit expected by the market if the option expires ITM. In some embodiments, the option is a call, wherein the calculation of the investor's expected profit for the option utilizes a formula consisting essentially of: target stock price−strike price−premium. In other embodiments, the option is a put, wherein the calculation of the investor's expected profit for the option utilizes a formula consisting essentially of: strike price−target stock price−premium. In some embodiments, the tool for transforming the probability of the option expiring ITM generates outputs comprising one or more of: premium, probability of option expiring ITM, market's expected stock price, market's expected leverage, and investor's expected leverage. In some embodiments, the method further comprises the step of demonstrating the determination of an option margin of safety, the option margin of safety consisting of: the difference between the investor's expectations and the market's expectations with regard to stock price.

In another aspect, disclosed herein are computer-implemented methods of investor education in the field of valuing options, the method comprising the steps of: demonstrating calculation of probability of an option expiring ITM; demonstrating calculation of profit expected by the market if the option expires ITM; demonstrating calculation of the market's expected leverage for the option; demonstrating calculation of the investor's expected leverage for the option; and providing access to a tool for transforming the probability of the option expiring ITM into the market's expected leverage for the option and the investor's expected leverage, the tool created by instructions executed by a processing device; whereby at least one investor is educated in the field of valuing options; provided that one or more of the calculations are performed by a processing device. In some embodiments, the investor's expected leverage for the option is derived from the investor's target stock price. In some embodiments, the calculation of profit expected by the market if the option expires ITM utilizes a formula consisting essentially of: (probability of the option expiring OTM) (loss expected by the market if the option expires OTM)/(probability of the option expiring ITM). In some embodiments, the calculation of the market's expected leverage for the option utilizes a formula consisting essentially of: profit expected by the market if the option expires ITM/premium. In further embodiments, the market's expected leverage for the option is expressed as a ratio profit expected by the market if the option expires ITM per dollar of premium:1. In some embodiments, the calculation of the market's expected leverage for the option utilizes a formula consisting essentially of: probability of the option expiring OTM/probability of the option expiring ITM. In some embodiments, the calculation of the investor's expected leverage for the option utilizes a formula consisting essentially of: investor's expected profit for the option/premium. In further embodiments, the investor's expected leverage for the option is expressed as a ratio of expected profit for the option per dollar of premium:1. In some embodiments, the tool for transforming the probability of the option expiring ITM generates outputs comprising one or more of: premium, probability of option expiring ITM, market's expected stock price, market's expected leverage, and investor's expected leverage. In some embodiments, the method further comprises the step of demonstrating the determination of an option margin of safety, the option margin of safety consisting of: the difference between the investor's expectations and the market's expectations with regard to leverage.

### BRIEF DESCRIPTION OF THE DRAWINGS

FIG. 1 shows a traditional options chain.

FIG. 2 shows a first non-limiting example of a tool for transforming the probability of the option expiring ITM into the market's expected stock price if the option expires ITM, the market's expected leverage for the option, and the investor's expected leverage; in this case, a tool accepting both live options data feeds as well as user-entered inputs.

FIG. 3 shows second non-limiting example of a tool for transforming the probability of the option expiring ITM into the market's expected stock price if the option expires ITM, the market's expected leverage for the option, and the investor's expected leverage; in this case, a tool accepting user-entered inputs.

FIG. 4 shows non-limiting example of an options chain demonstrating the methodologies disclosed herein.

### DETAILED DESCRIPTION OF THE INVENTION

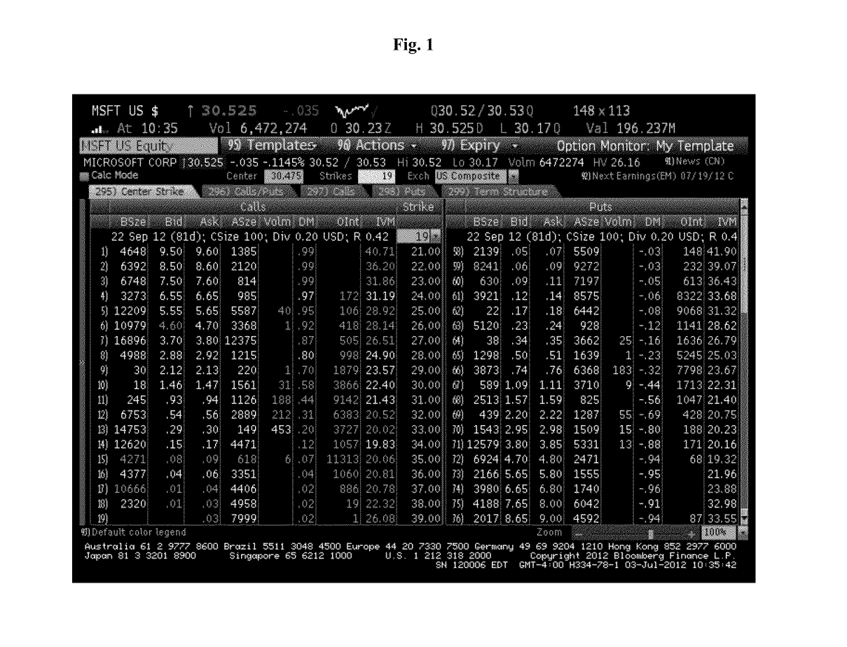

Existing methodologies fail to simplify options valuation and fail to adequately facilitate focus on future price expectations when trading options. For example, traditional methods fail to educate investors on how to utilize option premiums to determine the market's expectations and fail to educate investors on how quickly and easily to compare the market's expectations to their own expectations. By way of further example, FIG. 1 demonstrates a traditional options chain, which is often intimidating and not adequately informative for a new or non-professional options trader.

Described herein, in certain embodiments, are computer-implemented methods of investor education in the field of valuing options, the method comprising the steps of: demonstrating calculation of probability of an option expiring ITM; demonstrating calculation of profit expected by the market if the option expires ITM; demonstrating calculation of the market's expected stock price if the option expires ITM; demonstrating calculation of the market's expected leverage for the option if the option expires ITM; demonstrating calculation of the investor's expected profit for the option; demonstrating calculation of the investor's expected leverage for the option; and providing access to a tool for transforming the probability of the option expiring ITM into the market's expected stock price if the option expires ITM, the market's expected leverage for the option, and the investor's expected leverage, the tool created by instructions executed by a processing device; whereby at least one investor is educated in the field of valuing options; provided that one or more of the calculations are performed by a processing device.

Also described herein, in certain embodiments, are computer-implemented method of investor education in the field of valuing options, the method comprising the steps of: demonstrating calculation of probability of an option expiring ITM; demonstrating calculation of profit expected by the market if the option expires ITM; demonstrating calculation of the market's expected stock price if the option expires ITM; demonstrating calculation of the investor's expected profit for the option; and providing access to a tool for transforming the probability of the option expiring ITM into the market's expected stock price if the option expires ITM, the tool created by instructions executed by a processing device; whereby at least one investor is educated in the field of valuing options; provided that one or more of the calculations are performed by a processing device.

Also described herein, in certain embodiments, are computer-implemented methods of investor education in the field of valuing options, the method comprising the steps of: demonstrating calculation of probability of an option expiring ITM; demonstrating calculation of profit expected by the market if the option expires ITM; demonstrating calculation of the market's expected leverage for the option; demonstrating calculation of the investor's expected leverage for the option; and providing access to a tool for transforming the probability of the option expiring ITM into the market's expected leverage for the option and the investor's expected leverage, the tool created by instructions executed by a processing device; whereby at least one investor is educated in the field of valuing options; provided that one or more of the calculations are performed by a processing device.

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Investor Education

In some embodiments, the methods, systems, and software described herein are useful for specialized education and training. In further embodiments, the methods, systems, and software described herein are useful for education and training of investors/traders. In still further embodiments, the methods, systems, and software described herein are useful for education and training in the field of valuing options for the purpose of selecting options for investment.

In some embodiments, the education and training is provided in a live environment, such as a classroom. In some embodiments, the education and training is provided via distance learning techniques and equipment. In further embodiments, the education and training is provided via the Internet. In some embodiments, the education and training is synchronous and provided in real-time or substantially real-time. In other embodiments, the education and training is asynchronous and provided from an archive or repository of training materials.

In some embodiments, the education and training comprises methods of demonstrating calculations, comparisons, and evaluations of stock option parameters. In further embodiments, the demonstrations and/or calculations are performed by a computer or with the use of a computer. In some embodiments, the education and training comprises methods of providing access to tools for calculation, transformation, and presentation of stock option parameters. In some embodiments, the tools further provide alters for various stock option parameters. In further embodiments, the tools are computer-based. In further embodiments, the tools are web-based.

Many students and/or learners are suitable recipients of the specialized education and training described herein. In some embodiments, suitable students and/or learners include financial investing amateurs, beginners, or lay people. In other embodiments, suitable students and/or learners include financial investing professionals and experienced traders who are new to options valuation and trading.

### Probability of an Option Expiring ITM

In light of the disclosure provided herein, those of ordinary skill in the art will recognize that options have three possible outcomes at expiration: 1) in-the-money (ITM); 2) out-the-money (OTM); and 3) at-the-money (ATM) (usually included in the OTM outcome because an ATM option is still worth zero). In some embodiments, the methods, systems, and software described herein include demonstration of determination of the probability of an option expiring ITM (% ITM).

In some embodiments, the demonstration of determination of the probability of an option expiring ITM is a part of a computer-implemented educational experience. In further embodiments, the computer-implemented educational experience is a live seminar, class, or training. In other embodiments, the computer-implemented educational experience is an online tutorial, distance learning program, or e-learning course. In some embodiments, the demonstration of determination of the probability of an option expiring ITM is live and provided synchronously in real-time. In other embodiments, the demonstration of determination of the probability of an option expiring ITM is archived and provided asynchronously. In some embodiments, the demonstration of determination of the probability of an option expiring ITM comprises use of a computer-based tool for transforming data.

In some embodiments, the demonstration includes demonstration of inputs used to determine the probability of a particular option expiring ITM. In further embodiments, the inputs demonstrated include, for example, stock price, strike, interest rates, dividends, premium, expiry, and volatility. Many mathematical models are suitable for determination of the probability of a particular option expiring ITM. In some embodiments, determination of the probability of a particular option expiring ITM is achieved by computer-based application of the Black-Scholes model. In other embodiments, determination of the probability of a particular option expiring ITM is achieved by computer-based application of the Black-Scholes-Merton model. In yet other embodiments, determination of the probability of a particular option expiring ITM is achieved by computer-based application of the binomial model. In various embodiments, the probability is expressed, for example, as a percentage or a decimal. In some embodiments, the probability is expressed as an ITM score, rating, or ranking.

In some embodiments, the demonstration includes demonstration of determination of the probability of an option expiring OTM. In further embodiments, demonstration of determination of the probability of an option expiring OTM comprises subtracting the probability of an option expiring ITM from 100. In some embodiments, the demonstration includes demonstration of how different strikes affect the probability of an option expiring ITM and/or OTM.

### Profit Expected by the Market if an Option Expires ITM

In some embodiments, the methods, systems, and software described herein include demonstration of determination of the market's expected investor profit if an option expires ITM (ITM $ profit). In some embodiments, the demonstration of determination of the market's expected investor profit if an option expires ITM is a part of a computer-implemented educational experience. In further embodiments, the computer-implemented educational experience is a live seminar, class, or training. In other embodiments, the computer-implemented educational experience is an online tutorial, distance learning program, or e-learning course. In some embodiments, the demonstration of determination of the market's expected investor profit if an option expires ITM is live and provided synchronously in real-time. In other embodiments, the demonstration of determination of the market's expected investor profit if an option expires ITM is archived and provided asynchronously. In some embodiments, the demonstration of determination of the market's expected investor profit if an option expires ITM comprises use of a computer-based tool for transforming data.

In some embodiments, the demonstration includes demonstration of determination of the market's expected investor loss if the option expires OTM (OTM $ loss). In further embodiments, demonstration of determination of the market's expected investor loss if the option expires OTM comprises demonstrating that the expected loss is the premium paid. In some embodiments, the demonstration includes demonstration of equivalence of expected profit when expiring ITM with expected loss when expiring OTM.

### Market's Expected Stock Price if an Option Expires ITM

In some embodiments, the methods, systems, and software described herein include expression of market expectations as an expected stock price. In further embodiments, the methods, systems, and software described herein include demonstration of determination of the market's expected stock price if an option expires ITM. In still further embodiments, the methods, systems, and software described herein transform a probability of an option expiring ITM into a market expected stock price.

In some embodiments, the demonstration of determination of the market's expected stock price if an option expires ITM is a part of a computer-implemented educational experience. In further embodiments, the computer-implemented educational experience is a live seminar, class, or training. In other embodiments, the computer-implemented educational experience is an online tutorial, distance learning program, or e-learning course. In some embodiments, the demonstration of determination of the market's expected stock price if an option expires ITM is live and provided synchronously in real-time. In other embodiments, the demonstration of determination of the market's expected stock price if an option expires ITM is archived and provided asynchronously. In some embodiments, the demonstration of determination of the market's expected stock price if an option expires ITM comprises use of a computer-based tool for transforming data.

In some embodiments, the demonstration includes demonstration of inputs used to determine the market's expected stock price if an option expires ITM. In further embodiments, the inputs demonstrated include, for example, strike price, premium, and ITM $ profit. In some embodiments, determination of the market's expected stock price if a call expires ITM is achieved by computer-based application of a formula comprising: strike price+premium+ITM $ profit. In some embodiments, determination of the market's expected stock price if a put expires ITM is achieved by computer-based application of a formula comprising: strike price−premium−ITM $ profit.

### Market's Expected Leverage for an Option if the Option Expires ITM

In some embodiments, the methods, systems, and software described herein include expression of market expectations as a leverage number. In further embodiments, the leverage number comprises reward (e.g., profit) expected for $1.00 of risk (e.g., premium paid). In still further embodiments, the methods, systems, and software described herein include demonstration of determination of the market's expected leverage for an option if the option expires ITM.

In some embodiments, the demonstration of determination of the market's expected leverage for an option if the option expires ITM is a part of a computer-implemented educational experience. In further embodiments, the computer-implemented educational experience is a live seminar, class, or training. In other embodiments, the computer-implemented educational experience is an online tutorial, distance learning program, or e-learning course. In some embodiments, the demonstration of determination of the market's expected leverage for an option if the option expires ITM is live and provided synchronously in real-time. In other embodiments, the demonstration of determination of the market's expected leverage for an option if the option expires ITM is archived and provided asynchronously. In some embodiments, the demonstration of determination of the market's expected leverage for an option if the option expires ITM comprises use of a computer-based tool for transforming data.

In some embodiments, the demonstration includes demonstration of inputs used to determine the market's expected leverage for an option if the option expires ITM. In further embodiments, the inputs demonstrated include, for example, expected profit if the option expires ITM, premium, probability of the option expiring ITM, and probability of the option expiring OTM. In some embodiments, determination of the market's expected leverage for an option if the option expires ITM is achieved by computer-based application of a formula comprising: expected profit if the option expires ITM/premium. In other embodiments, determination of the market's expected leverage for an option if the option expires ITM is achieved by computer-based application of a formula comprising: probability of an option expiring OTM/probability of an option expiring ITM. A market's expected leverage is suitably expressed in a variety of forms. In a particular embodiment, the market's expected leverage for an option if the option expires ITM is suitably expressed as a ratio of ITM $ profit for every $1.00 of premium:1.

In some embodiments, the demonstration includes demonstration of how different probabilities of an option expiring ITM affect the market's expected leverage for an option. In further embodiments, the demonstration includes demonstration of construction of a chart displaying an expected leverage for each of a range of probabilities of an option expiring ITM.

### Investor's Expected Profit for an Option

In some embodiments, the methods, systems, and software described herein utilize an investor's future expectations. In further embodiments, an investor's future expectations are embodied by a target stock price and/or an investor's expected profit for an option. In some embodiments, the methods, systems, and software described herein include demonstration of determination of an investor's expected profit for an option.

In some embodiments, the demonstration of determination of an investor's expected profit for an option is a part of a computer-implemented educational experience. In further embodiments, the computer-implemented educational experience is a live seminar, class, or training. In other embodiments, the computer-implemented educational experience is an online tutorial, distance learning program, or e-learning course. In some embodiments, the demonstration of determination of an investor's expected profit for an option is live and provided synchronously in real-time. In other embodiments, the demonstration of determination of an investor's expected profit for an option is archived and provided asynchronously. In some embodiments, the demonstration of determination of an investor's expected profit for an option comprises use of a computer-based tool for transforming data.

In some embodiments, the demonstration includes demonstration of inputs used to determine an investor's expected profit for an option. In further embodiments, the inputs demonstrated include, for example, target stock price, strike price, and premium. In some embodiments, determination of an investor's expected profit for a call is achieved by computer-based application of a formula comprising: target stock price−strike price−premium. In some embodiments, determination of an investor's expected profit for a put is achieved by computer-based application of a formula comprising: strike price−target stock price−premium.

In some embodiments, the demonstration includes demonstration of re-determining an investor's target stock price throughout the life of an options contract to determine the effect on the investor's expected profit for the option.

### Investor's Expected Leverage for an Option

In some embodiments, the methods, systems, and software described herein utilize an investor's future expectations. In further embodiments, an investor's future expectations are embodied by a target stock price, an investor's expected profit for an option, and/or an investor's expected leverage for an option. In some embodiments, the investor's expected leverage comprises reward (e.g., profit) expected for $1.00 of risk (e.g., premium paid). In further embodiments, the methods, systems, and software described herein include demonstration of determination of an investor's expected leverage for an option.

In some embodiments, the demonstration of determination of an investor's expected leverage for an option is a part of a computer-implemented educational experience. In further embodiments, the computer-implemented educational experience is a live seminar, class, or training. In other embodiments, the computer-implemented educational experience is an online tutorial, distance learning program, or e-learning course. In some embodiments, the demonstration of determination of an investor's expected leverage for an option is live and provided synchronously in real-time. In other embodiments, the demonstration of determination of an investor's expected leverage for an option is archived and provided asynchronously. In some embodiments, the demonstration of determination of an investor's expected leverage for an option comprises use of a computer-based tool for transforming data.

In some embodiments, the demonstration includes demonstration of inputs used to determine the investor's expected leverage for an option. In further embodiments, the inputs demonstrated include, for example, the investor's expected profit for the option and the initial option premium. In some embodiments, determination of the investor's expected leverage for an option is achieved by computer-based application of a formula comprising: investor's expected profit/initial option premium. An investor's expected leverage is suitably expressed in a variety of forms. In a particular embodiment, the investor's expected leverage for an option is suitably expressed as a ratio of $ profit for every $1.00 of premium:1.

In some embodiments, the demonstration includes demonstration of how target stock prices affect the investor's expected leverage for an option. In further embodiments, the demonstration includes demonstration of construction of a chart displaying an expected leverage for each of a range of target stock prices. In some embodiments, the demonstration includes demonstration of how to use an investor's expected leverage for an option as a comparable reference point with evaluating an option.

### Tool for Transforming Data

In some embodiments, the methods, systems, and software described herein include to a tool for transforming data, or use of the same. In further embodiments, the transformations include application of the methodologies disclosed herein. In still further embodiments, a tool for transforming data disclosed herein transforms the probability of an option expiring ITM into, for example, the market's expected stock price if the option expires ITM, the market's expected leverage for the option, and the investor's expected leverage.

In some embodiments, the methods disclosed herein include the step of providing access to a tool for transforming data disclosed herein. In further embodiments, the methods disclosed herein include the step of providing access to a tool for transforming the probability of an option expiring ITM into, for example, the market's expected stock price if the option expires ITM, the market's expected leverage for the option, and the investor's expected leverage. Access is provided in many suitable ways. In various embodiments, access to a tool for transforming data disclosed herein is provided by, presenting one or more images of the tool, providing a link to use the tool, providing a link to download the tool, emailing the tool, demonstrating use of the tool in a live educational presentation, and demonstrating use of the tool in a pre-recorded educational presentation.

In some embodiments, a tool for transforming data is used by an instructor as part of a demonstration disclosed herein. In some embodiments, a tool for transforming data is used by an instructor to perform a calculation disclosed herein. In some embodiments, a tool for transforming data is used by a student or a learner to practice or explore methodologies demonstrated by an instructor. In some embodiments, a tool for transforming data is used by a student or a learner to perform calculations demonstrated by an instructor. In some embodiments, a tool for transforming data disclosed herein is utilized by a student to transform the market's expectations to an easily understood number in order to quantify and compare the market's expectations with their own.

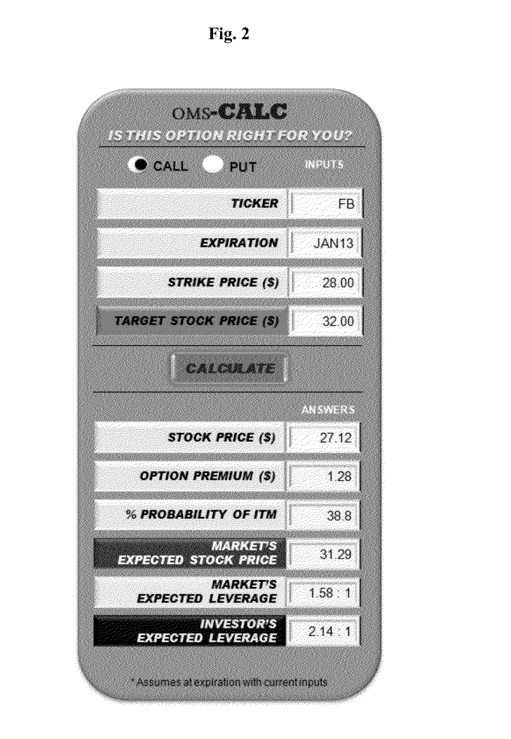

Referring to FIG. 2, in a particular embodiment, a tool for transforming data accepts inputs including an option type (e.g., call or put), ticker symbol, option expiration, strike price, and investor target stock price. Further in this embodiment, the tool displays stock price and option premium and the tool calculates and displays probability of the option expiring ITM the market's expected stock price, the market's expected leverage, and the investor's expected leverage, each of which is discussed herein. In this embodiment, the tool accepts live market data feeds as well as user-entered inputs.

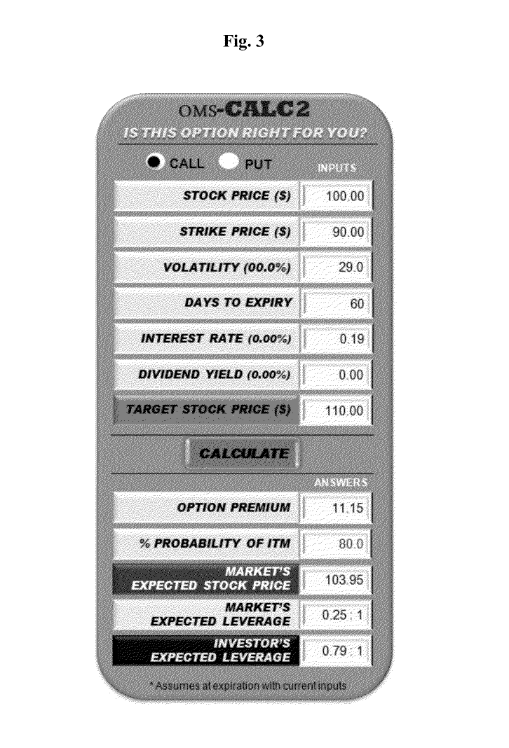

Referring to FIG. 3, in a particular embodiment, a tool for transforming data accepts inputs including an option type (e.g., call or put), stock price, strike price, volatility days to expiry, interest rate dividend yield and an investor's target stock price. Further in this embodiment, the tool displays option premium and the tool calculates and displays probability of the option expiring ITM the market's expected stock price, the market's expected leverage, and the investor's expected leverage, each of which is discussed herein. In this embodiment, the tool accepts user-entered inputs.

In some embodiments, a tool for transforming data disclosed herein transforms data for one option at a time. In other embodiments, a tool for transforming data disclosed herein transforms data for a plurality of options simultaneously. In various embodiments, a tool for transforming data disclosed herein transforms data for at least 2, 3, 4, 5, 6, 7, 8, 9, 10, 11, 12, 13, 14, 15, 16, 17, 18, 19, 20, 30, 40, 50, 60, 70 80, 90, 100 or more options simultaneously, including increments therein. In certain embodiments, a tool for transforming data disclosed herein transforms data for a particular options chain simultaneously.

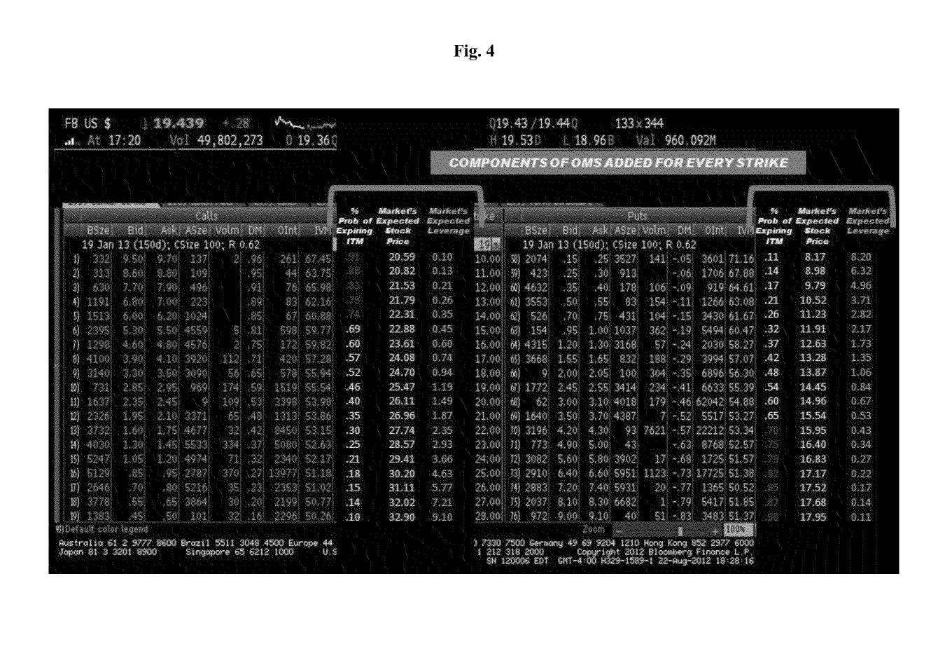

Referring to FIG. 4, in a particular embodiment, a tool for transforming data is integrated with an options chain to provide the probability of each option expiring ITM and transforming the data to further provide the market's expected stock price if each option expires ITM and the market's expected leverage for each option. In this embodiment, a novel options chain as such is utilized by a student to transform the market's expectations to an easily understood numbers in order to quantify and compare the market's expectations with their own.

In some embodiments, a tool for transforming data disclosed herein further provides automated alerts for stock option parameters. Alerts are provided via a number of suitable methods including, by way of non-limiting examples, email, SMS, MMS, voice mail, automated phone call, blog post, microblog post, social media post, or combinations thereof. In some embodiments, alerts are provided via the interface of the tool by highlighting, coloring, bolding, or otherwise drawing attention to one or more alter parameters. Many option parameters are suitable for triggering an automated alert.

In some embodiments, the tool is implemented as a software application or a software module executed by a processing device. In various embodiments, the tool is implemented as a web application, a mobile application, and/or a standalone application.

### Digital Processing Device

In some embodiments, the methods, systems, and software described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

### Non-Transitory Computer Readable Storage Medium

In some embodiments, the methods, systems, and software disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Computer Program

In some embodiments, the methods, systems, and software disclosed herein include at least one computer program, or use of the same. A computer program includes a sequence of instructions, executable in the digital processing device's CPU, written to perform a specified task. In light of the disclosure provided herein, those of skill in the art will recognize that a computer program may be written in various versions of various languages. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft® .NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Mobile Application

In some embodiments, a computer program includes a mobile application provided to a mobile digital processing device. In some embodiments, the mobile application is provided to a mobile digital processing device at the time it is manufactured. In other embodiments, the mobile application is provided to a mobile digital processing device via the computer network described herein.

In view of the disclosure provided herein, a mobile application is created by techniques known to those of skill in the art using hardware, languages, and development environments known to the art. Those of skill in the art will recognize that mobile applications are written in several languages. Suitable programming languages include, by way of non-limiting examples, C, C++, C#, Objective-C, Java™, Javascript, Pascal, Object Pascal, Python™, Ruby, VB.NET, WML, and XHTML/HTML with or without CSS, or combinations thereof.

Suitable mobile application development environments are available from several sources. Commercially available development environments include, by way of non-limiting examples, AirplaySDK, alcheMo, Appcelerator®, Celsius, Bedrock, Flash Lite, .NET Compact Framework, Rhomobile, and WorkLight Mobile Platform. Other development environments are available without cost including, by way of non-limiting examples, Lazarus, MobiFlex, MoSync, and Phonegap. Also, mobile device manufacturers distribute software developer kits including, by way of non-limiting examples, iPhone and iPad (iOS) SDK, Android™ SDK, BlackBerry® SDK, BREW SDK, Palm® OS SDK, Symbian SDK, webOS SDK, and Windows® Mobile SDK.

Those of skill in the art will recognize that several commercial forums are available for distribution of mobile applications including, by way of non-limiting examples, Apple® App Store, Android™ Market, BlackBerry® App World, App Store for Palm devices, App Catalog for webOS, Windows® Marketplace for Mobile, Ovi Store for Nokia® devices, Samsung® Apps, and Nintendo® DSi Shop.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the methods, systems, and software disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the methods, systems, and software disclosed herein include one or more databases, or use of the same. In view of the disclosure provided herein, those of skill in the art will recognize that many databases are suitable for storage and retrieval of stock option and option chain information. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

1. A computer-implemented method of investor education in the field of valuing options, the method comprising the steps of:
a. providing to another individual, via a processing device, a computer program including instructions executed by the processing device configured to create a tool for transforming the probability of an option expiring in-the-money (ITM) into the market's expected stock price if the option expires in-the-money (ITM), the market's expected leverage for the option, and the investor's expected leverage;
b. calculating, by the tool, the probability of the option expiring in-the-money (ITM);
c. calculating, by the tool, the profit expected by the market if the option expires in-the-money (ITM);
d. calculating, by the tool, the market's expected stock price if the option expires in-the-money (ITM);
e. calculating, by the tool, the market's expected leverage for the option if the option expires in-the-money (ITM);
f. calculating, by the tool, the investor's expected profit for the option; and
g. calculating, by the tool, the investor's expected leverage for the option; and
h. displaying and demonstrating each calculation to the individual, whereby the individual is educated in the field of valuing options.

2. The method of claim 1, wherein the investor's expected profit for the option is derived from the investor's target stock price.

3. The method of claim 1, wherein the investor's expected leverage for the option is derived from the investor's target stock price.

4. The method of claim 1, wherein the calculation of profit expected by the market if the option expires in-the-money (ITM) utilizes a formula consisting essentially of: (probability of the option expiring out-of-money (OTM)) (loss expected by the market if the option expires out-of-money (OTM))/(probability of the option expiring in-the-money (ITM)).

5. The method of claim 1, wherein the option is a call, wherein the calculation of the market's expected stock price if the option expires in-the-money (ITM) utilizes a formula consisting essentially of: strike price+premium+profit expected by the market if the option expires in-the-money (ITM).

6. The method of claim 1, wherein the option is a put, wherein the calculation of the market's expected stock price if the option expires in-the-money (ITM) utilizes a formula consisting essentially of: strike price−premium−profit expected by the market if the option expires in-the-money (ITM).

7. The method of claim 1, wherein the calculation of the market's expected leverage for the option utilizes a formula consisting essentially of: profit expected by the market if the option expires in-the-money (ITM)/premium.

8. The method of claim 7, wherein the market's expected leverage for the option is expressed as a ratio profit expected by the market if the option expires in-the-money (ITM) per dollar of premium:1.

9. The method of claim 1, wherein the calculation of the market's expected leverage for the option utilizes a formula consisting essentially of: probability of the option expiring out-of-money (OTM)/probability of the option expiring in-the-money (ITM).

10. The method of claim 1, wherein the option is a call, wherein the calculation of the investor's expected profit for the option utilizes a formula consisting essentially of: target stock price−strike price−premium.

11. The method of claim 1, wherein the option is a put, wherein the calculation of the investor's expected profit for the option utilizes a formula consisting essentially of: strike price−target stock price−premium.

12. The method of claim 1, wherein the calculation of the investor's expected leverage for the option utilizes a formula consisting essentially of: investor's expected profit for the option/premium.

13. The method of claim 12, wherein the investor's expected leverage for the option is expressed as a ratio of expected profit for the option per dollar of premium:1.

14. The method of claim 1, wherein the tool for transforming the probability of the option expiring in-the-money (ITM) accepts inputs comprising one or more of: type of option (call or put), stock price, strike price, volatility, days to expiry of the option, interest rate, dividend yield, and target stock price, ticker, and expiration date.

15. The method of claim 1, wherein the tool for transforming the probability of the option expiring in-the-money (ITM) generates outputs comprising one or more of: premium, probability of option expiring in-the-money (ITM), market's expected stock price, market's expected leverage, and investor's expected leverage.

16. The method of claim 1, further comprising the step of demonstrating to the individual the determination, by the tool, of an option margin of safety, the option margin of safety consisting of: the difference between the investor's expectations and the market's expectations with regard to stock price or leverage.

17. The method of claim 1, further comprising the step of demonstrating to the individual the advantage of:
a. buying a call option where investor's target stock price>the market's expected stock price if the option expires in-the-money (ITM); and
b. selling a call option where investor target stock price<the market's expected stock price if the option expires in-the-money (ITM).

18. The method of claim 1, further comprising the step of demonstrating to the individual the advantage of:
a. selling a put option where the investor's target stock price>the market's expected stock price if the option expires in-the-money (ITM); and
b. buying a put option where the investor's target stock price<the market's expected stock price if the option expires in-the-money (ITM).

19. The method of claim 1, further comprising the step of demonstrating to the individual the advantage of:
a. buying an option where the investor's expected leverage>the market's expected leverage; and
b. selling an option where the investor's expected leverage<the market's expected leverage.

20. The method of claim 1, further comprising the step of demonstrating to the individual the effect of expiration date or target stock price on valuation of the option.

21. The method of claim 1, further comprising the step of demonstrating to the individual a technique for >70% probability of in-the-money (ITM) call options, comprising evaluating the corresponding put option with the same strike and expiration.

22. The method of claim 1, further comprising the step of demonstrating to the individual a technique for >70% probability of in-the-money (ITM) put options, comprising evaluating the corresponding call option with the same strike and expiration.

23. A computer-implemented method of investor education in the field of valuing options, the method comprising the steps of:
a. providing to another individual, via a processing device, a computer program including instructions executed by the processing device configured to create a tool for transforming the probability of an option expiring in-the-money (ITM) into the market's expected stock price if the option expires in-the-money (ITM);
b. calculating, by the tool, the probability of the option expiring in-the-money (ITM);
c. calculating, by the tool, the profit expected by the market if the option expires in-the-money (ITM);
d. calculating, by the tool, the market's expected stock price if the option expires in-the-money (ITM); and
e. calculating, by the tool, the investor's expected profit for the option; and
f. displaying and demonstrating each calculation to the individual, whereby the individual is educated in the field of valuing options.

24. The method of claim 23, wherein the investor's expected profit for the option is derived from the investor's target stock price.

25. The method of claim 23, wherein the tool for transforming the probability of the option expiring in-the-money (ITM) generates outputs comprising one or more of: premium, probability of option expiring in-the-money (ITM), market's expected stock price, market's expected leverage, and investor's expected leverage.

26. The method of claim 23, further comprising the step of demonstrating to the individual the determination of an option margin of safety, the option margin of safety consisting of: the difference between the investor's expectations and the market's expectations with regard to stock price.

27. A computer-implemented method of investor education in the field of valuing options, the method comprising the steps of:
a. providing to another individual, via a processing device, a computer program including instructions executed by the processing device configured to create a tool for transforming the probability of an option expiring in-the-money (ITM) into the market's expected leverage for the option and the investor's expected leverage;
b. calculating, by the tool, the probability of the option expiring in-the-money (ITM);
c. calculating, by the tool, the profit expected by the market if the option expires in-the-money (ITM);
d. calculating, by the tool, the market's expected leverage for the option; and
e. calculating, by the tool, the investor's expected leverage for the option; and
f. displaying and demonstrating each calculation to the individual, whereby the individual is educated in the field of valuing options.

28. The method of claim 27, wherein the investor's expected leverage for the option is derived from the investor's target stock price.

29. The method of claim 27, wherein the tool for transforming the probability of the option expiring in-the-money OTM) generates outputs comprising one or more of: premium, probability of option expiring in-the-money OTM), market's expected stock price, market's expected leverage, and investor's expected leverage.

30. The method of claim 27, further comprising the step of demonstrating to the individual the determination of an option margin of safety, the option margin of safety consisting of: the difference between the investor's expectations and the market's expectations with regard to leverage.
